(19) United States
(12) Patent Application Publication
(10) Pub. No.: US 2025/0328967 A1
(43) Pub. Date: Oct. 23, 2025

(54) SYSTEMS, METHODS, AND DEVICES FOR GENERATIVE ARTIFICIAL INTELLIGENCE (AI)-DRIVEN CONTENT GENERATION AND MULTI-CHANNEL DISTRIBUTION

(71) Applicant: Pollen LLC, North Charleston, SC (US)

(72) Inventors: Carl K. Rust, III, Charleston, SC (US); Michael Gasser, Charleston, SC (US); William Ragans, Seabook, SC (US); Nathan Scott Herr, Saint Johns, FL (US); Matthew Colin Fitz-Henry, Ponte Vedra, FL (US)

(21) Appl. No.: 19/185,144

(22) Filed: Apr. 21, 2025

Related U.S. Application Data
(60) Provisional application No. 63/636,498, filed on Apr. 19, 2024.

(51) Int. Cl. G06Q 50/00

(52) U.S. Cl. CPC G06Q 50/01

(57) ABSTRACT

Systems, methods, and devices for generative artificial intelligence (AI)-driven content generation and multi-channel distribution are disclosed. According to an aspect, a system includes a post content generator configured to associate content with a user. Further, the post content generator is configured utilize artificial intelligence functionalities to generate additional content based on the content associated with the user. The post content generator is also configured to automatically communicate, to one or more social media platforms, the generated additional content via one or more channels for distribution to one or more other users.

### CROSS-REFERENCE TO RELATED APPLICATIONS

This application claims priority to U.S. Provisional Patent Application No. 63/636,498, filed Apr. 19, 2024, the disclosure of which is incorporated herein by reference in its entirety.

### BACKGROUND

Social media platforms such as FACEBOOK® social media service, INSTAGRAM® social media service, LINKEDIN® social media service, X™ (formerly TWITTER″) social media service, TIKTOK® social media service, YOUTUBE® social media service, and others are integral to modern digital marketing strategies. These platforms offer organizations a range of publishing formats and audience targeting tools designed to generate visibility, engagement, and conversions. Content published on these platforms can take the form of text posts, images, videos, carousels, stories, shorts, and reels—each with its own engagement conventions and measurement standards.

Given their ubiquity, these platforms present a challenge when it comes to evaluating performance across multiple channels. Metrics are platform-specific, differ in how they are measured or named, and do not lend themselves to easy cross-comparison. For example, an engagement rate on one platform might include views in its denominator, whereas another might calculate engagement rate based on reach or impressions. This inconsistency makes it difficult for businesses and marketing teams to evaluate the holistic impact of their social content strategy.

Traditional approaches to performance evaluation require manual compilation of data from each platform, alignment of metrics into shared definitions, and subjective interpretation of what constitutes success. While some software solutions attempt to consolidate performance data, they often treat each metric in isolation, fail to normalize for platform-specific context, or lack meaningful scoring systems that reflect strategic importance and historical relevance.

In view of the foregoing, there is a need for improved systems for performance evaluation of social media services and for the presentation of this performance evaluation to users.

### SUMMARY OF THE DISCLOSURE

The presently disclosed subject matter relates to systems, methods, and devices for generative AI-driven content creation and multi-channel distribution, including but not limited to social media platforms, email lists, and SMS/MMS text message lists. According to an aspect, a method includes associating content with a user; utilizing generative AI to augment and/or generate additional content based on the content associated with the user; and automatically transmitting, by the computing device, the content and the augmented and/or additional content to one or more channels selected from social media platforms, email lists, and SMS/MMS text message lists.

According to an aspect, a system includes a post content generator configured to associate content with a user. Further, the post content generator is configured to utilize artificial intelligence functionalities to generate additional content based on the content associated with the user. The post content generator is also configured to automatically communicate, to one or more social media platforms, the generated additional content via one or more channels for distribution to one or more other users.

### BRIEF DESCRIPTION OF DRAWINGS

Having thus described the presently disclosed subject matter in general terms, reference will now be made to the accompanying Drawings, which are not necessarily drawn to scale, and wherein:

FIG. 1 is a block diagram of an example system 100 for utilizing artificial intelligence functionalities to generate content and to automatically communicate, to one or more social media platforms, the generated content via one or more channels for distribution to one or more other users in accordance with embodiments of the present disclosure;

FIG. 2 is a flowchart of an example method for utilizing artificial intelligence functionalities to generate content and to automatically communicate, to one or more social media platforms, the generated content via one or more channels for distribution to one or more other users in accordance with embodiments of the present disclosure;

FIG. 3 is a flowchart of a method for unique identifier generation in accordance with embodiments of the present disclosure;

FIG. 4 is a flowchart of a method for image library/image importation in accordance with embodiments of the present disclosure;

FIG. 5 is a flowchart of a method for caption generation in accordance with embodiments of the present disclosure;

FIG. 6 is a flowchart of an example method for hashtag generation in accordance with embodiments of the present disclosure;

FIG. 7 is a flowchart of an example method for awaiting and implementing action regarding automatically-generated posts in accordance with embodiments of the present disclosure;

FIG. 8 is a flowchart of a method of AI in accordance with embodiments of the present disclosure; and

FIG. 9 is a flowchart of a method of a retraining process in accordance with embodiments of the present disclosure.

### DETAILED DESCRIPTION OF THE DISCLOSURE

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Articles “a” and “an” are used herein to refer to one or to more than one (i.e. at least one) of the grammatical object of the article. By way of example, “an element” means at least one element and can include more than one element.

The use herein of the terms “including,” “comprising,” or “having,” and variations thereof is meant to encompass the elements listed thereafter and equivalents thereof as well as additional elements. Embodiments recited as “including,” “comprising,” or “having” certain elements are also contemplated as “consisting essentially of” and “consisting” of those certain elements.

Unless otherwise defined, all technical terms used herein have the same meaning as commonly understood by one of ordinary skill in the art to which this disclosure belongs.

As used herein, the term “memory” is generally a storage device of a computing device. Examples include, but are not limited to, read-only memory (ROM) and random access memory (RAM).

The device or system for performing one or more operations on a memory of a computing device may be a software, hardware, firmware, or combination of these. The device or the system is further intended to include or otherwise cover all software or computer programs capable of performing the various heretofore-disclosed determinations, calculations, or the like for the disclosed purposes. For example, exemplary embodiments are intended to cover all software or computer programs capable of enabling processors to implement the disclosed processes. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed below.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl, or other suitable programming languages.

As referred to herein, the terms “computing device” and “entities” should be broadly construed and should be understood to be interchangeable. They may include any type of computing device, for example, a server, a desktop computer, a laptop computer, a smart phone, a cell phone, a pager, a personal digital assistant (PDA, e.g., with GPRS NIC), a mobile computer with a smartphone client, or the like.

As referred to herein, a user interface is generally a system by which users interact with a computing device. A user interface can include an input for allowing users to manipulate a computing device, and can include an output for allowing the system to present information and/or data, indicate the effects of the user's manipulation, etc. An example of a user interface on a computing device (e.g., a mobile device) includes a graphical user interface (GUI) that allows users to interact with programs in more ways than typing. A GUI typically can offer display objects, and visual indicators, as opposed to text-based interfaces, typed command labels or text navigation to represent information and actions available to a user. For example, an interface can be a display window or display object, which is selectable by a user of a mobile device for interaction. A user interface can include an input for allowing users to manipulate a computing device, and can include an output for allowing the computing device to present information and/or data, indicate the effects of the user's manipulation, etc. An example of a user interface on a computing device includes a GUI that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

As referred to herein, a computer network may be any group of computing systems, devices, or equipment that are linked together. Examples include, but are not limited to, local area networks (LANs) and wide area networks (WANs). A network may be categorized based on its design model, topology, or architecture. In an example, a network may be characterized as having a hierarchical internetworking model, which divides the network into three layers: access layer, distribution layer, and core layer. The access layer focuses on connecting client nodes, such as workstations to the network. The distribution layer manages routing, filtering, and quality-of-server (QoS) policies. The core layer can provide high-speed, highly-redundant forwarding services to move packets between distribution layer devices in different regions of the network. The core layer typically includes multiple routers and switches.

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Articles “a” and “an” are used herein to refer to one or to more than one (i.e. at least one) of the grammatical object of the article. By way of example, “an element” means at least one element and can include more than one element.

“About” is used to provide flexibility to a numerical endpoint by providing that a given value may be “slightly above” or “slightly below” the endpoint without affecting the desired result.

The use herein of the terms “including,” “comprising,” or “having,” and variations thereof is meant to encompass the elements listed thereafter and equivalents thereof as well as additional elements. Embodiments recited as “including,” “comprising,” or “having” certain elements are also contemplated as “consisting essentially of” and “consisting” of those certain elements.

Recitation of ranges of values herein are merely intended to serve as a shorthand method of referring individually to each separate value falling within the range, unless otherwise indicated herein, and each separate value is incorporated into the specification as if it were individually recited herein. For example, if a range is stated as between 1%-50%, it is intended that values such as between 2%-40%, 10%-30%, or 1%-3%, etc. are expressly enumerated in this specification. These are only examples of what is specifically intended, and all possible combinations of numerical values between and including the lowest value and the highest value enumerated are to be considered to be expressly stated in this disclosure.

Unless otherwise defined, all technical terms used herein have the same meaning as commonly understood by one of ordinary skill in the art to which this disclosure belongs.

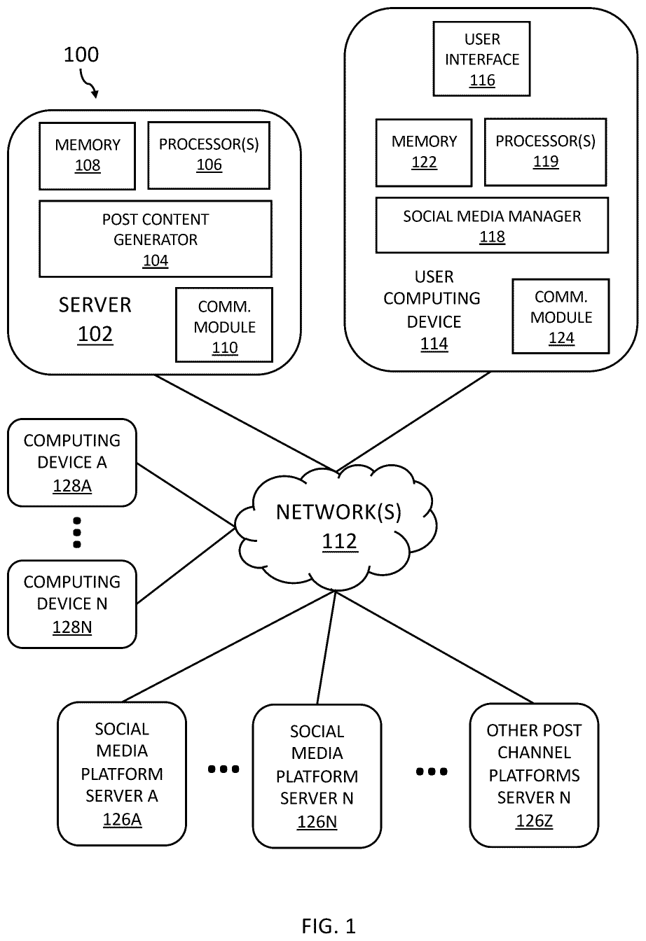

FIG. 1 illustrates a block diagram of an example system 100 for utilizing artificial intelligence functionalities to generate content and to automatically communicate, to one or more social media platforms, the generated content via one or more channels for distribution to one or more other users in accordance with embodiments of the present disclosure. Referring to FIG. 1, the system 100 includes a server 102 configured to associate content with a user. The server 102 is also configured to utilize artificial intelligence functionalities to generate additional content based on the content associated with the user. Further, the server 102 is configured to automatically communicate, to one or more social media platforms, the generated additional content via one or more channels for distribution to one or more other users.

The server 102 can include a post content generator 104 for implementing the aforementioned functionalities of the server 102 and other functionalities. For example, the server 102 can include suitable hardware, software, and/or firmware for implementing the functionalities described herein. For example, the server 102 can include one or more processors 106 that implement instructions stored in memory 108 for implementing the functionalities.

The server 102 may include a communications module 110 configured to enable the server 102 to communicate with other computing devices. For example, the communications module 110 may be configured to communicate with other computing devices via one or more networks 112. Example networks include, but are not limited to, the internet, a cellular network, a local area network, and the like.

In embodiments, server 102 can include functionalities for assisting a user to manage a social media marketing account. For example, a user of computing device 114 may utilize a user interface 116 of the computing device 114 for engaging an application for social media marketing. The application may be a web application provided by the server 102 via the network(s) 112. By use of the application, a user of the computing device 114 can manage the posting of content for marketing or other purposes via one or more social media platforms. In addition, the application provided by the content engagement manager 104 can present data indicative of user engagement with the posted social media content. For example, the user interface 116 can present indicators of a measure of user engagement with posted social media content, a rate of user engagement with the social media content, a measure of reach of users with the social media content, a number of impressions with the social media content, likes, reactions, comments, shares, click-throughs, swipe-ups, completions, a conversion action, and the like.

The computing device 114 can include a post manager 118 for implementing the aforementioned functionalities of the computing device 114 and other functionalities. For example, the computing device 114 can include suitable hardware, software, and/or firmware for implementing the functionalities described herein. For example, the computing device 114 can include one or more processors 119 that implement instructions stored in memory 122 for implementing the functionalities.

The computing device 114 may include a communications module 124 configured to enable the computing device 114 to communicate with other computing devices. For example, the communications module 110 may be configured to communicate with other computing devices via network(s) 112.

The user of computing device 114 can have accounts with one or more social media platforms. Functionalities of the social media platforms may be implemented by social media platform servers 126A-126N (where “N” is variable to indicate a suitable number of servers). The user of computing device 114 may interact with the servers 126A-126N via network(s) 112. For example, the user may use the post manager 118 for generating content and posting the content across one or more social media platforms enabled by the servers 126A-126N.

Other users may be presented with and view the content by use of computing devices 128A-128N. For example, a user of computing device 128A may via text, images, videos, or the like posted by the user of computing device 114. In this example, the text, images, or video can be posted and stored at server 126, and subsequently communicated to computing device 128A for presentation.

Continuing the aforementioned example, the user of computing device 128A can engage or interact with the posted social media content. For example, a user interface of the computing device 128A may display or otherwise present the social media content. The user can use the user interface of the computing device 128A to, for example, like the post or otherwise interact with the post. In this way, the engagement can demonstrate that the post was effective in capturing the attention of the user.

Servers 126A-126N may each maintain tracking data of users' engagement with the posted content of the user of computing device 114 or other users. The data may be stored in the servers 126A-126N. Server 102 may be communicatively connected to the servers 126A-126N for accessing the engagement data for determining various measures of users' engagement with posted social media content.

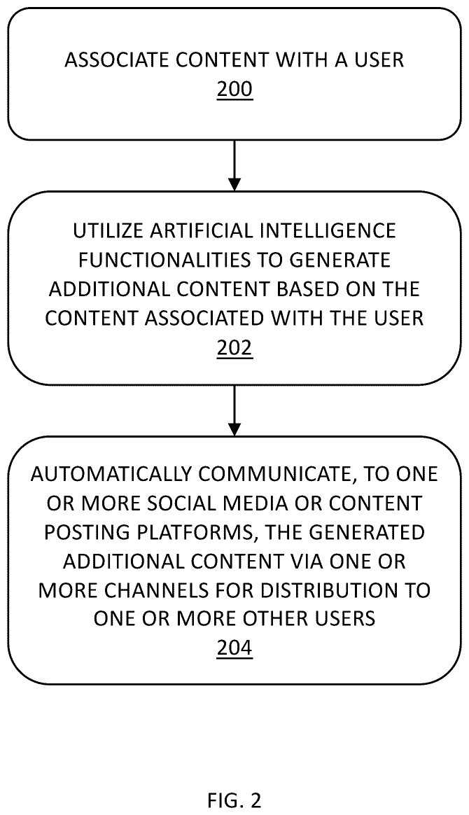

FIG. 2 illustrates a flowchart of an example method for utilizing artificial intelligence functionalities to generate content (e.g., text, email, and chat) and to automatically communicate, to one or more social media platforms, the generated content via one or more channels for distribution to one or more other users in accordance with embodiments of the present disclosure. The method is described by example as being implemented by the server 102 shown in FIG. 1, but it should be understood that the method may be implemented by any other computing device or multiple computing devices.

Referring to FIG. 2, the method includes associating 200 content with a user. For example, the user of computing device 114 can generate and post content to social media, SMS, email, chat (Slack, WhatsApp, etc.), or other communication channel by use of the post manager 118 and by interaction with the user interface 116. The content may be, for example, images, video, and/or text. The content may be communicated to server 102, and subsequently scheduled for posting by the post content generator 104. The post content generator 104 may post the content to social media, SMS, email, chat (Slack, WhatsApp, etc.), or other communication channel via one or more channels. The post content generator 104 can store the content in memory 108. Content generated by the user of the computing device 114 can be stored in memory 108 over a period of time. Further, the post content generator 104 can generate a variety of content types including but not limited to: metadata tags for the imported images via an image analysis technique, hashtags for the content using a hashtag generation model, and the like.

The method of FIG. 2 also includes utilizing 202 artificial intelligence functionalities to generate additional content based on the content associated with the user. Continuing the aforementioned example, the post content generator 104 can be configured to implement artificial intelligence functionalities to generate additional content based on the content associated with the user of the computing device 114. For example, images, text, and/or video similar to the images, text, and/or video associated with the user of the computing device 114 can be generated by artificial intelligence functionalities. This additional content can be stored in memory 108.

The method of FIG. 2 also includes automatically communicating 204, to one or more content posting channels, the generated additional content via one or more channels for distribution to one or more other users. Continuing the aforementioned example, the post content generator 104 can automatically communicate, to one or more content posting channels, the generated additional content via one or more channels for distribution to one or more other users. For example, the additional content can be communicated to servers 126A-126N on a schedule for communication to the computing devices of other users via one or more channels (e.g., email, text, IM, etc.).

As referred to herein, the terms “artificial intelligence credits” and “AI credits” can refer to credits used in an action-based token system consumed by each artificial operation (e.g., caption generation, hashtag creation).

As referred to herein, the term “zero-click” can refer to a fully automated content creation and posting without real-time user input.

As referred to herein, the term “score” can refer to a numeric value (e.g., 0-5) computed a predetermined time period (e.g., 48 hours) subsequent to posting, aggregating weighted channel metrics, or the like.

As referred to herein, the term “unique identifier” can refer to a machine-generated token that captures a brand's voice profile.

As referred to herein, the term “relative performance factor” can refer to a dimensionless value equal to the ratio of a weighted engagement metric for a given post to that metric's historical average for the user's account.

As referred to herein, the term “Normalization Function” can refer to a mathematical mapping (e.g., min-max scaling or z-score compression) that converts summed relative performance factors into a bounded scale (e.g., 0-5 scale).

As referred to herein, the term “dynamic weight adjustment” can refer to a process by which an artificial intelligence module retrains per-metric weights based on cumulative performance data and supervised feedback.

As referred to herein, the terms “artificial intelligence credit system” and “AI credit system” refers to an action-based token scheme in which each generative AI operation (e.g., caption generation, hashtag batch creation, zero-click post scheduling) consumes a predefined number of credits. Credits may be purchased or allotted per account and are decremented in real time according to the operation's complexity. For example, caption generation for a single image consumes one credit, whereas channel-specific multi-format captioning consumes three credits.

In accordance with embodiments, a content posting platform is disclosed that can provide automated content generation, media selection, and post scheduling based on a learned brand voice and narrative. This platform is referred to herein as the “AI/zero-click” technology, and it represents a groundbreaking artificial intelligence integration within a content posting/social media management platform. This technology can utilize natural language processing and machine learning algorithms to analyze historical social media content, enabling it to generate new posts that maintain brand consistency. This technology can intelligently select media from the client's library, generate content based on per brand trained AI models, or stock sources and schedule posts for optimal engagement, building a cohesive brand story over time. This AI-driven approach allows for a seamless, efficient management of content posting and social media strategies, ensuring brand consistency and strategic content deployment without manual intervention.

The “AI/zero-click” technologies introduce a comprehensive solution to these challenges by leveraging advanced AI to automate the content creation and scheduling process. This technology learns a brand's voice from historical content posts, intelligently selects relevant media from the brand's library or integrated stock image sources, and crafts captions that resonate with the brand's established voice. Furthermore, it builds a cohesive brand narrative across multiple posts and determines optimal posting times based on a combination of industry best practices and specific audience engagement data.

In accordance with embodiments, “AI/zero-Click” employs natural language processing (NLP) and machine learning algorithms to analyze a brand's historical outbound communications and social media content, learning its unique voice, tone, and messaging themes. The AI can subsequently apply this learned voice to generate among other things: new posts, post captions, images, image captions, ensuring brand consistency across content.

For media selection, the AI can prioritize the client's own media library(ies), ensuring brand-specific imagery is used wherever possible. The client can upload and segment media into multiple libraries to populate discrete campaigns, allowing the separation of, limitation of platform destination, and differing timings between campaigns running concurrently. If suitable media is not available in the client's library(ies), the AI seamlessly defaults to integrated stock image libraries, selecting images that complement the post's content and brand aesthetic.

The AI further enhances brand storytelling by integrating themes and messages across a series of posts, contributing to a coherent narrative that supports the brand's marketing and informational objectives. These themes and messages are initially populated through the use of a client specific questionnaire process to assess brand voice, marketing objectives, product and service specificity, and brand specific negative keywords (words and messaging to be avoided on behalf of the client).

Post scheduling is optimized by the AI through an analysis of platform-specific ideal posting times, combined with insights gained from the performance of the brand's previous posts and a variety of other time based performance factors. This approach ensures that each post is published when it is most likely to achieve high engagement. Post scheduling can be segmented and differentiated between multiple campaigns running simultaneously. This includes selection of platform destination(s), frequency of publishing, content format, and media library access for each campaign.

In embodiments, a post content generator as disclosed herein can use “AI/zero-click” within a platform to manage a brand's content posting strategy. After initially setting up and providing access to the brand's historical posts and media library, the AI of the post content generator can autonomously generate and schedule posts. The AI of the post content generator can generate captions that reflect the brand's voice, selects fitting media, and schedules posts for optimal engagement times, all while weaving a consistent brand story across the content. This automation can allow the marketing manager to focus on strategic oversight and creative direction, rather than daily content management tasks.

General: AI+0-Click is an integrated system that employs unique processes to prompt various AI tools to use specific criteria to generate post content and automatically schedule said created content without direct input from a user at the time of creation. There are several key features that make up the AI-generated content as well as the factors that go into the scheduling of said content.

In accordance with embodiments, systems and methods disclosed herein can utilize one or more different processes for generating content, schedule generated content, and post-generated content. These include, but are not limited to, unique identifier generation, image library/image creation/image importing, caption generation, and the like. Additional description and examples follow.

### Unique Identifier Generation

In accordance with embodiments, a system as disclosed herein can use inputs from a business profile to send an API call to an AI engine that can receive those inputs and generate a unique identifier that, through a series of prompts can enable the system to take on a business voice, that can be updated through continuous use. This unique identifier can be used in conjunction with other inputs detailed herein that can serve as a base for auto-generated content.

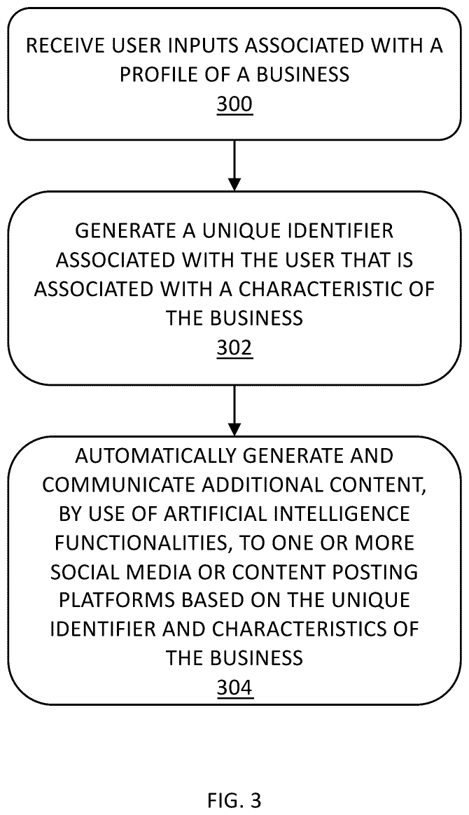

FIG. 3 illustrates a flowchart of a method for unique identifier generation in accordance with embodiments of the present disclosure. It is noted that the method is described by example as being implemented by the system 100 shown in FIG. 1, but it should be understood that the method may be implemented by any other suitable system. Specifically, many of the functions/steps of the method are described as being implemented by the post content generator 104 residing within the server 102, but these functions/steps may be implemented by one or more computing devices working in coordination.

Referring to FIG. 3, the method includes receiving 300 user inputs associated with a profile of a business. For example, the user of computing device 114 can input information associated with the person's business. This user input can be communicated to the server 102, where it is received by the post content generator 104.

The method of FIG. 3 also includes generating 302 a unique identifier associated with the user that is associated with a characteristic of the business. Continuing the aforementioned example, the post content generator 104 can generate a unique identifier associated with the user that is a characteristic of the business.

The method of FIG. 3 also includes automatically generating and communicating 304 additional content, by use of artificial intelligence functionalities, to one or more content posting channels based on the unique identifier and characteristic of the business. Continuing the aforementioned example, the post content generator 104 may generate additional content based on the unique identifier and characteristic of the business. Artificial intelligence functionalities may be used by the post content generator 104 for generating the additional content. This additional content may be communicated to servers 126A-126N for posting via one or more different channels. As an example, this may include embeddings for a large language model (LLM).

### Image Library/Image Creation/Image Import

In accordance with embodiments, when a user uploads an image into the image library (dependent on image library development) the user can have the ability to add captions or tags to the specific image. The image and its associated captions can be fed into an image analysis AI to create AI tags for the image. The user-generated and AI-generated captions and tags can be stored as metadata on the image for future AI and 0-Click use cases.

Each client can complete a brand survey. The brand survey text inputs serve as the initial brand voice prompt for the AI. This data can be continuously updated through user-generated and AI-generated captions and tags stored as metadata.

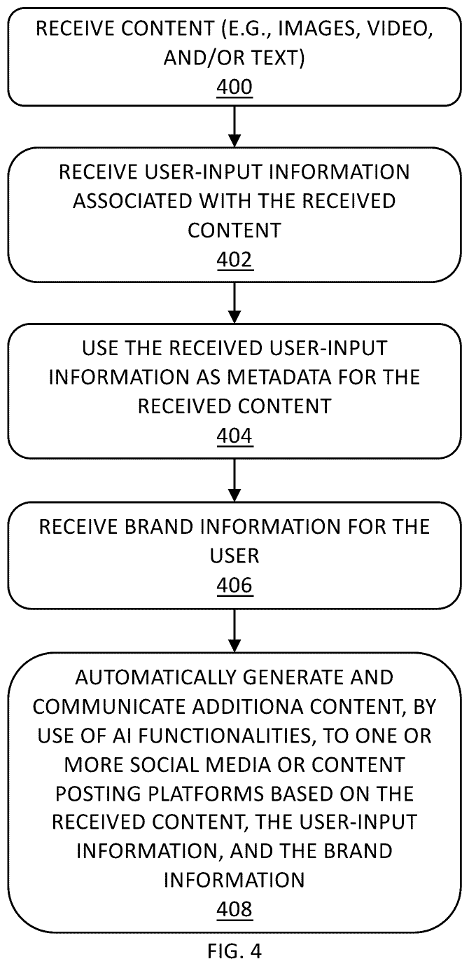

FIG. 4 illustrates a flowchart of a method for image library/image importation in accordance with embodiments of the present disclosure. It is noted that the method is described by example as being implemented by the system 100 shown in FIG. 1, but it should be understood that the method may be implemented by any other suitable system. Specifically, many of the functions/steps of the method are described as being implemented by the post content generator 104 residing within the server 102, but these functions/steps may be implemented by one or more computing devices working in coordination.

Referring to FIG. 4, the method includes receiving 400 content (e.g., images, video and/or text). For example, the user of the computing device 114 may communicate to server 102 various images, video, and/or text for posting to one or more content posting channels via one or more channels. Alternatively, the content may be communicated to the server 102 as example content or reference content for posting. The post content generator 104 may receive and store the content in memory 108.

The method of FIG. 4 also includes receiving 402 user-input information associated with the received content. Continuing the aforementioned example, the user of the computing device 114 may input a tag or caption for the content. This information may be used for identifying the subject of the content or other information so that the content may be later referenced or identified. This user-input information may be received by the server 102. Further, the post content generator 104 can store this user-input information in memory 108.

The method of FIG. 4 also includes using 404 the received user-input information as metadata for the received content. Continuing the aforementioned example, the post content generator 104 may use the received user-input information as metadata for the received content stored in memory 108.

The method of FIG. 4 also includes receiving 406 brand information for the user. Continuing the aforementioned example, the post content generator 104 may receive brand information from the user of the computing device 114. For example, the user may input brand information into the user interface 116 by completing a survey. This brand information may be communicated to the server 102. Further, the post content generator 104 may store the brand information in memory 108.

The method of FIG. 4 also includes automatically generating and communicating 408 additional content, by use of artificial intelligence functionalities, to one or more social media platforms based on the received content, the user-input information, and the brand information. Continuing the aforementioned example, the post content generator 104 may generate additional content based on the received content, the user-input information, and the brand information. Artificial intelligence functionalities may be used by the post content generator 104 for generating the additional social media content. This additional content may be communicated to servers 126A-126N for posting via one or more different channels.

### Caption Generation

Caption generation can allow uploaded images and their captions to be sent to a generative AI that can generate a related caption that satisfies the image used as well as input from the business profile that aligns the image and the outcomes wanted.

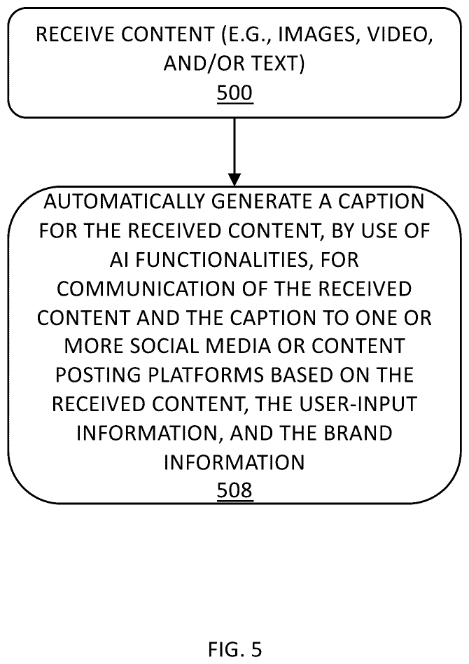

FIG. 5 illustrates a flowchart of a method for caption generation in accordance with embodiments of the present disclosure. It is noted that the method is described by example as being implemented by the system 100 shown in FIG. 1, but it should be understood that the method may be implemented by any other suitable system. Specifically, many of the functions/steps of the method are described as being implemented by the post content generator 104 residing within the server 102, but these functions/steps may be implemented by one or more computing devices working in coordination.

Referring to FIG. 5, the method includes receiving 500 content (e.g., images, video and/or text). For example, the user of the computing device 114 may communicate to server 102 various images, video, and/or text for posting to one or more content posting platforms via one or more channels. Alternatively, the content may be communicated to the server 102 as example content or reference content for posting. The post content generator 104 may receive and store the content in memory 108.

The method of FIG. 5 also includes automatically generating 502 a caption for the received content, by use of artificial intelligence functionalities, for communication of the received content and the caption to one or more social media platforms based on a characteristic of the content and brand information. Continuing the aforementioned example, the post content generator 104 may generate additional content based on a characteristic (e.g., a subject of an image or video, image analysis information of the content, etc.) of the received content and brand information of a user who uploaded the received content to the server 102. Artificial intelligence functionalities may be used by the post content generator 104 for generating the additional social media content. This additional content may be communicated to servers 126A-126N for posting via one or more different channels.

### Captions Revision

In accordance with embodiments, 1-Click caption generations can allow a user to not only generate a blanket caption, but also enhance a caption the user has written through use of AI Credits. For example, the user can communicate content to the server 104 along with a caption. Subsequently, as in the example of the method of FIG. 5, the post content generator 104 can generate another caption for use with the content. The two captions can be used together for posting to social media platforms in accordance with embodiments of the present disclosure.

### Hashtag Generation

In accordance with embodiments, a system as disclosed herein can generate Hashtags for each post, both with zero-click and 1-click postings.

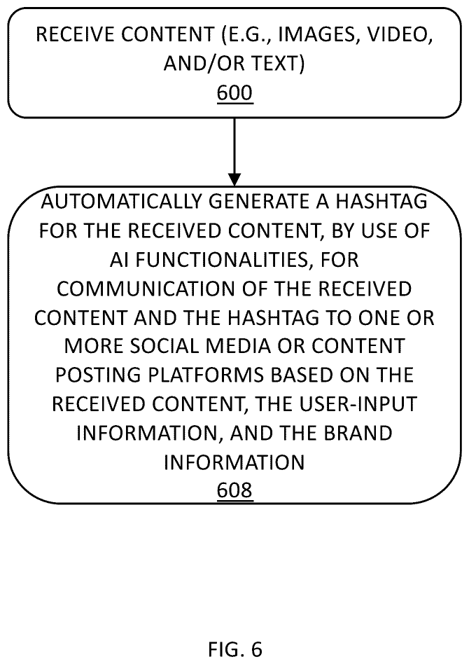

FIG. 6 illustrates a flowchart of an example method for hashtag generation in accordance with embodiments of the present disclosure. It is noted that the method is described by example as being implemented by the system 100 shown in FIG. 1, but it should be understood that the method may be implemented by any other suitable system. Specifically, many of the functions/steps of the method are described as being implemented by the post content generator 104 residing within the server 102, but these functions/steps may be implemented by one or more computing devices working in coordination.

Referring to FIG. 6, the method includes receiving 500 content (e.g., images, video and/or text). For example, the user of the computing device 114 may communicate to server 102 various images, video, and/or text for posting to one or more social media platforms via one or more channels. Alternatively, the content may be communicated to the server 102 as example content or reference content for posting. The post content generator 104 may receive and store the content in memory 108.

The method of FIG. 5 also includes automatically generating 502 a hashtag for the received content, by use of artificial intelligence functionalities, for communication of the received content and the hashtag to one or more content posting platforms based on a characteristic of the content and brand information. Continuing the aforementioned example, the post content generator 104 may generate a hashtag and additional content based on a characteristic (e.g., a subject of an image or video, image analysis information of the content, etc.) of the received content and brand information of a user who uploaded the received content to the server 102. Artificial intelligence functionalities may be used by the post content generator 104 for generating the hashtag and additional social media content. This hashtag and additional content may be communicated to servers 126A-126N for posting via one or more different channels.

### Channel-Specific Generation

The system can generate channel-specific content from a single image or caption. This will live as a setting and will use more AI credits. When media/content is fed through the AI prompt engine, the results can be tailored to be a Global generation or channel-specific generative content.

### Successful Post Enhancement

The system can use a user's successful posts to aid in the generation of 0-Click Content. Specifically, the images, timing of posts, and the unique identifiers on said posts.

### Scheduling

The system can look at a user's post history and determine which posts have scored well, the timing of the posts, as well as best industry channel-specific standards for scheduling and suggest/schedule the post.

### User Interactive Controls

Within the AI/0-Click settings, a user can specify and update specific components of AI and 0-Click to customize the way the system interacts with the user and their posts.

### Zero-Click

The system can use all of the above processes to generate what the system believes will be a successful post for the user. If the user has “Post Approval” set to True, then an approval of the 0-Click post may be needed for the post to proceed. If “Post Approval” is set to False, then no approval may be needed for the zero-click post to be posted to selected channels.

### Post-Approval Workflow

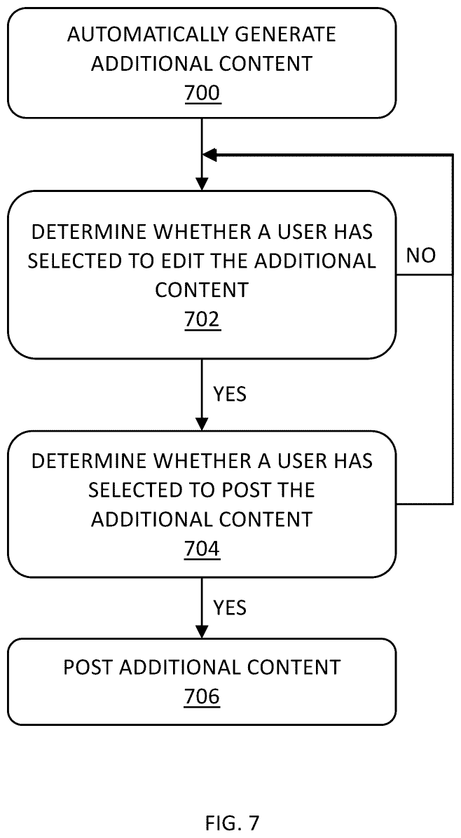

If “Post Approval” is enabled, generated posts enter a pending queue where the user may accept, edit via 1-Click, or reject before automatic posting. FIG. 7 illustrates a flowchart of an example method for awaiting and implementing action regarding automatically-generated posts in accordance with embodiments of the present disclosure. It is noted that the method is described by example as being implemented by the system 100 shown in FIG. 1, but it should be understood that the method may be implemented by any other suitable system. Specifically, many of the functions/steps of the method are described as being implemented by the post content generator 104 residing within the server 102, but these functions/steps may be implemented by one or more computing devices working in coordination.

Referring to FIG. 7, the method includes automatically generating 700 additional content. For example, the post content generator 104 can automatically generate additional content for posting as described by examples herein.

The method of FIG. 7 also includes determining 702 whether a user has selected to edit the additional content. Continuing the aforementioned example, the post content generator 104 can determining 702 whether a user has selected to edit the additional content. If the user has selected to edit, the post content generator 104 can edit the additional content accordingly and return to step 702. If the user has not selected to edit, the method may proceed to step 704.

At step 704, the method includes determining whether a user has selected to post the additional content. If the user selected not to post the additional content, the method can proceed to step 702. If the user selected to post the additional content, the method can include posting 706 the additional content in accordance with examples described herein.

### Non-Auto Post 0-Click Edits

If a zero-click created post should need to be edited and “EDIT” is selected, the created post can be directed to a scheduled 1 click post to enable edits. Full AI enhancement ability can be available to the user and associated credits used.

### AI Business Profile

The updated business profile can have inputs for the user to determine the type of business they are, their interests, and goal-oriented outcomes for using the system. Once a user saves their business profile, an API call will be generated to an AI model that will generate a specific unique identifier for that business and its associated details which can enable the system to use said identifier for future AI captions, hashtag, image, and zero-click generation.

### AI Credits

The AI credit system refers to an action-based token scheme in which each generative AI operation (e.g., caption generation, hashtag batch creation, zero-click post scheduling) consumes a predefined number of credits. Credits may be purchased or allotted per account and are decremented in real time according to the operation's complexity. For example, caption generation for a single image consumes one credit, whereas channel-specific multi-format captioning consumes three credits.

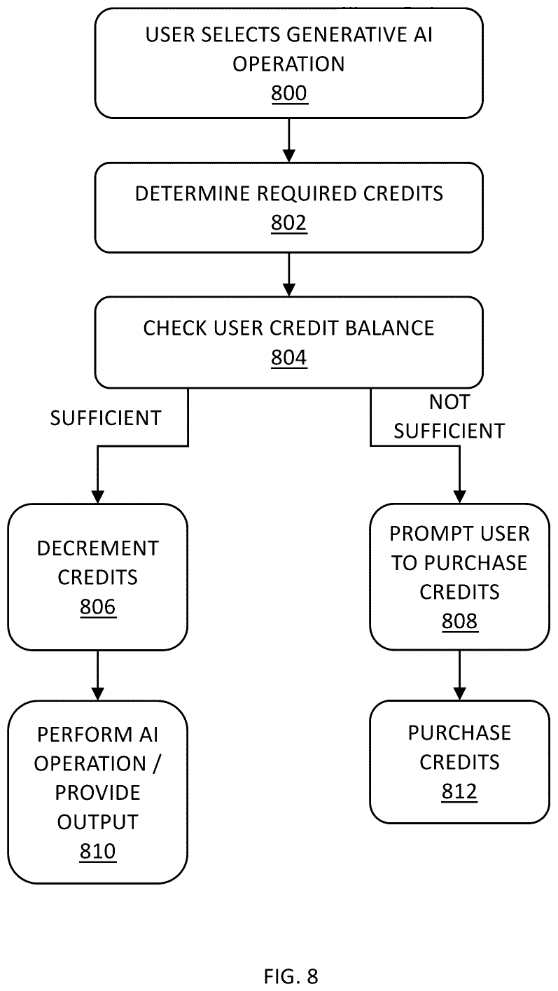

FIG. 8 illustrates a flowchart of AI in accordance with embodiments of the present disclosure. It is noted that the method is described by example as being implemented by the system 100 shown in FIG. 1, but it should be understood that the method may be implemented by any other suitable system. Specifically, many of the functions/steps of the method are described as being implemented by the post content generator 104 residing within the server 102, but these functions/steps may be implemented by one or more computing devices working in coordination.

Referring to FIG. 8, the method includes user selection 800 of a generative AI operation. At step 802, the required credits for the operation is determined. Subsequently at step 804, the user's credit balance is checked for sufficient credits. If there are sufficient credits, the method proceeds to step 806. Otherwise, if there are not sufficient credits, the method proceeds to step 808.

With continuing reference to FIG. 8, the method includes decrementing the credits from the user's balance at step 806 and also performing the selected operation and providing output of the operation at step 810.

At step 808 of the method, the user can be prompted to purchase credits. Subsequently, the user can purchase credits (step 812) and the method can proceed to check balance at step 804.

Cross-Platform Performance Score (“Pollen Score”) (FIGS. 7-9, 11)

The system computes a cross-platform performance score, referred to herein as the “Pollen Score,” which normalizes and aggregates engagement metrics from multiple social media channels into a single bounded value (0-5). This computation proceeds through five primary phases:
(A) Metric Availability Mapping: API calls to each platform determine which engagement metrics (likes, comments, shares, impressions, views, etc.) are available.
(B) Weighted Value Computation: Each raw metric is multiplied by a platform-and-metric-specific weight (e.g., comments×1.0; shares×1.5).
(C) Historical Benchmarking: Weighted values are compared to account-level historical averages to yield relative performance factors.
(D) Normalization & Scaling: Relative factors are summed and passed through a normalization function to map the result into the 0-5 scale.
(E) Aggregate Score Generation: The normalized factors are averaged to produce the final Pollen Score, which is stored and displayed in the analytics dashboard.

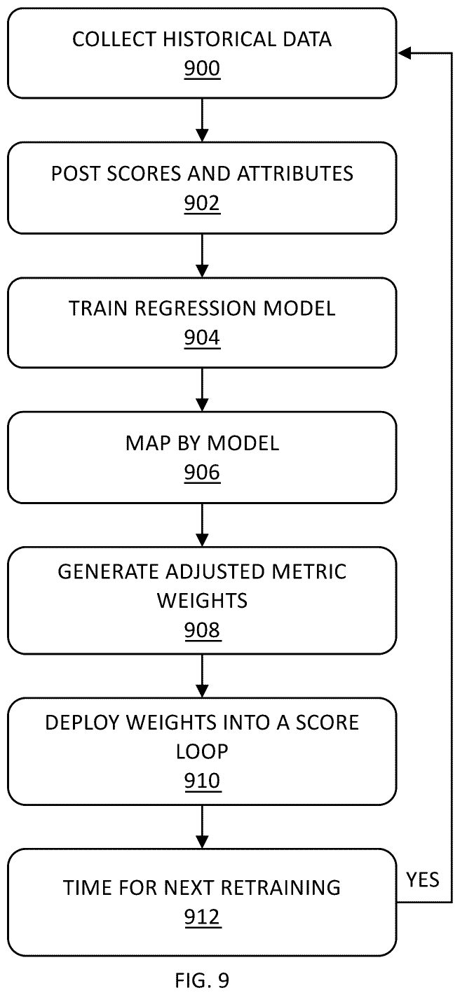

Dynamic AI-Driven Weight Adjustment: In embodiments, the system continuously updates per metric weights using a supervised machine learning model. Historical Pollen Scores and associated post attributes (media type, caption length, etc.) train a regression model that outputs adjusted weights. These updated weights are deployed back into the Pollen Score computation loop. FIG. 9 illustrates this retraining process.

Referring to FIG. 9, the method includes collecting 900 historical data. The method also includes posting 902 scores and attributes such as media type, caption, length, and the like.

The method of FIG. 9 also includes training 904 a regression model. Further, the method includes the model learning 906 mapping, such as attributes, optimal weights, and the like.

The method of FIG. 9 also includes generating 908 adjusted metric weights. Further, the method includes deploying 910 weights into a score loop. The method also includes recomputing 910 scores with new weights.

The method of FIG. 9 also includes determining 912 a time for retraining. If it is time to retrain, the method can proceed to step 900.

TABLE 2

| Engagement Metric | Example Weight |
|---|---|
| Like | 0.5 |
| Comment | 1.0 |
| Share | 1.5 |
| View Duration | 0.2 |

TABLE 3
Sample Pollen Score Computation

| | Raw | | Weighted | Hist. | Rel. | |
|---|---|---|---|---|---|---|
| Metric | Value | Weight | Value | Avg | Factor | Contribution |
| Likes | 200 | 0.5 | 100 | 80 | 1.25 | 1.25 |
| Comments | 50 | 1.0 | 50 | 40 | 1.25 | 1.25 |
| Shares | 10 | 1.5 | 15 | 10 | 1.50 | 1.50 |
| Average | | | | | | 1.33 |

### Algorithm

In accordance with embodiments, an algorithm can be a matrix of scores, values, and D-002 Weights that will take a channel's performance metrics and define an integer of the weighted performance, then average all of the selected channel's score integers into a single integer. The idea is to standardize a score of un-similar components through equations with their given weights to align into a similar integer to formulate the Algorithm.

### Individual Post Performance

Each post D-001 channel has a set of analytical data that is retrieved from the API. All data has been hand selected for each D-001 channel to maximize the visibility of how well a post is performing. Each channel within the post can have a different set of Metrics that align with the performance of the post specific to what the channel values.

### Weighted Performance

Each metric within a channel is given “Weight” towards the value of each metric depending upon the value each channel has given towards the particular metric. The weight varies per channel and metric. The idea is to give a value of importance per metric towards performance.

### Score Distribution

There is a score derived from each channel. Each channels score has a different meaning of importance. With the Algorithm, each channel's analytic data (with different inputs) is turned into an integer score of 0-5.

### Aggregate Score

Each score is a “Pollen” score of that Channel per post.

### Score

In accordance with embodiments, a score is a single numeric score that is an average of all available Channel scores. A single post score number (numeric value) will be assigned to a post after 48 hours and will show the overall success of the post with a single number 0-5 also shown in “Logo's”.

### Definitions

Channel: Services or applications the user of “Pollen” connects with to access posting, contacts, or analytics functionality. They are not limited to current availability within the application.

Weights: The associated importance of a particular analytic and its associated value: i.e. “views” have a weight of 1 because they are less indicative of a successful post or reach of a post.

Score: The associated value derived from an analytic given data with its associated weight formulated into an integer that allows alignment of all metrics to an integer value.

The functional units described in this specification have been labeled as computing devices. A computing device may be implemented in programmable hardware devices such as processors, digital signal processors, central processing units, field programmable gate arrays, programmable array logic, programmable logic devices, cloud processing systems, or the like. The computing devices may also be implemented in software for execution by various types of processors. An identified device may include executable code and may, for instance, comprise one or more physical or logical blocks of computer instructions, which may, for instance, be organized as an object, procedure, function, or other construct. Nevertheless, the executable of an identified device need not be physically located together but may comprise disparate instructions stored in different locations which, when joined logically together, comprise the computing device and achieve the stated purpose of the computing device. In another example, a computing device may be a server or other computer located within a retail environment and communicatively connected to other computing devices (e.g., POS equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD), or a smart watch or some other wearable smart device. Some of the computer sensing may be part of the fabric of the clothes the user is wearing. A computing device can also include any type of conventional computer, for example, a laptop computer or a tablet computer. A typical mobile computing device is a wireless data access-enabled device (e.g., an iPHONE® smart phone, an iPAD® device, smart watch, or the like) that is capable of sending and receiving data in a wireless manner using protocols like the Internet Protocol, or IP, and the wireless application protocol, or WAP. This allows users to access information via wireless devices, such as smart watches, smart phones, mobile phones, pagers, two-way radios, communicators, and the like. Wireless data access is supported by many wireless networks, including, but not limited to, Bluetooth, Near Field Communication, CDPD, CDMA, GSM, PDC, PHS, TDMA, FLEX, ReFLEX, iDEN, TETRA, DECT, DataTAC, Mobitex, EDGE and other 2G, 3G, 4G, 5G, and LTE technologies, and it operates with many handheld device operating systems, such as EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone or smart watch that operates over GPRS (General Packet Radio Services), which is a data technology for GSM networks or operates over Near Field Communication e.g. Bluetooth. In addition to a conventional voice communication, a given mobile device can communicate with another such device via many different types of message transfer techniques, including Bluetooth, Near Field Communication, SMS (short message service), enhanced SMS (EMS), multi-media message (MMS), email WAP, paging, or other known or later-developed wireless data formats. Although many of the examples provided herein are implemented on smart phones, the examples may similarly be implemented on any suitable computing device, such as a computer.

An executable code of a computing device may be a single instruction, or many instructions, and may even be distributed over several different code segments, among different applications, and across several memory devices. Similarly, operational data may be identified and illustrated herein within the computing device and may be embodied in any suitable form and organized within any suitable type of data structure. The operational data may be collected as a single data set or may be distributed over different locations including over different storage devices, and may exist, at least partially, as electronic signals on a system or network.

The described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

The present subject matter may be a system, a method, and/or a computer program product. The computer program product may include a computer readable storage medium (or media) having computer readable program instructions thereon for causing a processor to carry out aspects of the present subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network, or Near Field Communication. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Javascript or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used, or modifications and additions may be made to the described embodiment for performing the same function without deviating therefrom. Therefore, the disclosed embodiments should not be limited to any single embodiment but rather should be construed in breadth and scope in accordance with the appended claims.

1. A system comprising:
a post content generator configured to:
associate content with a user;
utilize artificial intelligence functionalities to generate additional content based on the content associated with the user; and
automatically communicate, to one or more social media platforms, the generated additional content via one or more channels for distribution to one or more other users.

2. The system of claim 1, wherein the content associated with the user is content previously posted by the user.

3. The system of claim 1, wherein the content associated with the user includes one of a text post, an image, a video, a carousel, a story, a short, audio, an interactive element, and a reel.

4. The system of claim 1, wherein the additional content generated by the artificial intelligence functions includes one of a text post, an image, a video, a carousel, a story, a short, audio, an interactive element, and a reel.

5. The system of claim 1, wherein the post content generator is configured to associate the content with the user via an artificial intelligence engine that generates a unique identifier by use of business profile inputs.

6. The system of claim 1, wherein the content associated with the user includes images imported into an image library, and
wherein the post content generator is configured to generate metadata tags for the imported images via an image analysis technique.

7. The system of claim 1, wherein the post content generator is configured to generate and revise captions by use of artificial intelligence credits for both batch and on-demand workflows.

8. The system of claim 1, wherein the post content generator is configured to generate hashtags for the content using a hashtag generation model.

9. The system of claim 1, wherein the post content generator is configured to schedule posts based on user-specific engagement history and industry best-practice posting times.

10. The system of claim 1, wherein the post content generator is configured to compute a score for each post at a predetermined time subsequent to the respective post based on weighted channel metrics.

11. The system of claim 1, wherein the post content generator is configured to adapt the content to channel-specific formats and requirements.

12. The system of claim 1, wherein user approval of the generated additional content is required prior to communication.

13. A method comprising:
associating content with a user;
utilizing artificial intelligence functionalities to generate additional content based on the content associated with the user; and
automatically communicating, to one or more social media platforms, the generated additional content via one or more channels for distribution to one or more other users.

14. The method of claim 1, wherein the content associated with the user is content previously posted by the user.

15. The method of claim 1, wherein the content associated with the user includes one of a text post, an image, a video, a carousel, a story, a short, audio, an interactive element, and a reel.

16. The method of claim 1, wherein the additional content generated by the artificial intelligence functions includes one of a text post, an image, a video, a carousel, a story, a short, audio, an interactive element, and a reel.

17. The method of claim 1, further comprising associating the content with the user via an artificial intelligence engine that generates a unique identifier by use of business profile inputs.

18. The method of claim 1, wherein the content associated with the user includes images imported into an image library, and
wherein the method further comprising generating metadata tags for the imported images via an image analysis technique.

19. The method of claim 1, further comprising generating and revise captions by use of artificial intelligence credits for both batch and on-demand workflows.

20. The method of claim 1, further comprising generating hashtags for the content using a hashtag generation model.

21. The method of claim 1, further comprising scheduling posts based on user-specific engagement history and industry best-practice posting times.

22. The method of claim 1, further comprising computing a score for each post at a predetermined time subsequent to the respective post based on weighted channel metrics.

23. The method of claim 1, further comprising adapting the content to channel-specific formats and requirements.

24. The method of claim 1, wherein user approval of the generated additional content is required prior to communication.

25. A computer program product comprising a computer readable storage medium having program instructions embodied therewith, the program instructions executable by a computing device to cause the computing device to:
associate, by the computing device, content with a user;
utilize, by the computing device, artificial intelligence functionalities to generate additional content based on the content associated with the user; and
automatically communicate, by the computing device, to one or more social media platforms, the generated additional content via one or more channels for distribution to one or more other users.
